(19) United States
(12) Patent Application Publication
(10) Pub. No.: US 2005/0086481 A1
(43) Pub. Date: Apr. 21, 2005

(54) Naming of 802.11 group keys to allow support of multiple broadcast and multicast domains

(75) Inventor: Nancy Cam Winget, Mountain View, CA (US)

Correspondence Address: TUCKER, ELLIS & WEST LLP, 1150 HUNTINGTON BUILDING, 925 EUCLID AVENUE, CLEVELAND, OH, 44115-1475, US

(73) Assignee: Cisco Technology, Inc., San Jose, CA (US)

(21) Appl. No.: 10/686,205

(22) Filed: Oct. 15, 2003

(51) Int. Cl. H04L 9/00

(52) U.S. Cl. 713/176; 380/44; 380/270

(57) ABSTRACT

A method for transmitting multicast messages where a group key is generated for signing the multicast message transmitted on a network. Next, the system establishes a group key name corresponding to the group key. Once the group key name is established, the data packet is transmitted together with the group key name, the group key and the multicast message. Upon receipt, the recipient validates the group key name in the received data packet by comparing the received group key name to a group key name table in order to determine the intended group recipients.

### BACKGROUND OF THE INVENTION

The IEEE (Institute of Electrical and Electronic Engineers) 802.11 standard provides guidelines for allowing users to wirelessly connect to a network and access basic services provided therein. Additionally, the IEEE 802.11 standard provides guidelines for multicast transmissions sent via the wireless network.

Conventionally, the 802.11 standard for wireless networks presumes support for a single group key used for broadcast and multicast transmission to a client. This single group key structure becomes problematic in the event that a client or station belongs to several different multicast domains. For example, utilizing conventional methods, in the event that a client belongs to several different multicast domains, the client may receive packet data targeted for multicast groups whether or not the client is a member of the group.

Traditionally, a client or station must discern upon receipt of a multicast message whether or not it is an intended recipient of the message. This determination is usually accomplished when the receiving station encounters an error or failure in the decryption of the packet data. In other words, in order to determine if a client or station is the intended recipient of a multicast or broadcast message, it was necessary for the client to attempt decryption of the message packet ultimately tying up resources and increasing throughput time.

By properly assigning names for the encrypted group keys, it will be possible for clients and stations to differentiate between unicast and multicast keys. As well, the clients and stations will be able to discern the packets intentionally directed toward a target station or group of stations.

In other words, through proper key naming and identification, a client or station will be able to lookup the key name of a received packet and quickly determine whether the particular client or station was the intended receiver of a particular broadcast packet. If so, the client may accept and decrypt the remaining portion of the packet. On the other hand, if the client is not the intended recipient, the entire broadcast packet will be discarded whereby the decryption operation will not be executed. This bypass of the decryption process will inherently increase client throughput performance.

### SUMMARY OF THE INVENTION

The present invention disclosed and claimed herein, in one aspect thereof, comprises a system and method for transmitting multicast messages via a wireless network (e.g. IEEE 802.11). Initially, the present system and method may be configured to generate a group key for signing a multicast message transmitted on the network.

Next, a group key name may be established corresponding to the group key and configured to sign the multicast message transmitted to a predetermined group of clients on the network. Once the group key name is established, the data packet including the group key name, the group key and the multicast message may be transmitted to the target group.

Prior to transmission, the group key and the group key name may be added or embedded into the packet name extension of the transmitted packet. In accordance with the present system and method, the group key name may be established utilizing any user defined hash function.

Upon receipt, the recipient client(s) may validate the group key name received in the data packet. The group key name may be compared to a group key name table which is populated with predefined group key names. If a match exists in the local table, the remainder of the transmission may be decrypted. If a match does not exist, the remainder of the message may be discarded.

### BRIEF DESCRIPTION OF THE DRAWINGS

It will be appreciated that the illustrated boundaries of elements (e.g. boxes, groups of boxes, or other shapes) in the figures represent one example of the boundaries. One of ordinary skill in the art will appreciate that one element may be designed as multiple elements or that multiple elements may be designed as one element.

For a more complete understanding of the present system and the advantages thereof, reference is now made to the following description taken in conjunction with the accompanying drawings in which:

FIG. 1 illustrates a network block diagram that operates to facilitate multicast transmission of traffic to a number of wireless clients through a single access point, in accordance with a disclosed embodiment;

FIG. 2 illustrates an example of a conventional packet name extension format in accordance with the IEEE 802.11 standard.

FIG. 3 illustrates an example of a proposed packet name extension format in accordance with a disclosed embodiment.

FIG. 4 illustrates a network block diagram that operates to facilitate multicast transmission of traffic to a number of wireless clients through multiple access points, in accordance with a disclosed alternate embodiment; and

FIG. 5 illustrates a flow chart of the methodology outlining the information exchange between the various entities for authenticating and validating the transmission of multicast transmission in accordance with a disclosed embodiment.

### DETAILED DESCRIPTION OF THE INVENTION

The following includes definitions of selected terms used throughout the disclosure. The definitions include examples of various embodiments and/or forms of components that fall within the scope of a term and that may be used for implementation. Of course, the examples are not intended to be limiting and other embodiments may be implemented. Both singular and plural forms of all terms fall within each meaning:

“Computer-readable medium”, as used herein, refers to any medium that participates in directly or indirectly providing signals, instructions and/or data to one or more processors for execution. Such a medium may take many forms, including but not limited to, non-volatile media, volatile media, and transmission media. Non-volatile media may include, for example, optical or magnetic disks. Volatile media may include dynamic memory. Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, a PROM, an EPROM, a FLASH-EPROM, any other memory chip or cartridge, a carrier wave/pulse, or any other medium from which a computer, a processor or other electronic device can read. Signals used to propagate instructions or other software over a network, such as the Internet, are also considered a “computer-readable medium.”

“Internet”, as used herein, includes a wide area data communications network, typically accessible by any user having appropriate software.

“Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like. Logic may also be fully embodied as software.

“Software”, as used herein, includes but is not limited to one or more computer readable and/or executable instructions that cause a computer or other electronic device to perform functions, actions, and/or behave in a desired manner. The instructions may be embodied in various forms such as objects, routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software may be dependent on, for example, requirements of a desired application, the environment it runs on, and/or the desires of a designer/programmer or the like.

The following includes examples of various embodiments and/or forms of components that fall within the scope of the present system that may be used for implementation. Of course, the examples are not intended to be limiting and other embodiments may be implemented without departing from the spirit and scope of the invention.

The IEEE (Institute of Electrical and Electronic Engineers) 802.11 standard for wireless networks provides guidelines for allowing users to wirelessly connect to a network and access basic services provided therein. Additionally, the IEEE 802.11 standard provides guidelines and protocol for unicast and multicast transmissions. The content of the IEEE 802.11 specification standard is hereby incorporated into this specification by reference in its entirety.

Briefly describing one embodiment of the present system, it provides for an 802.11 network and corresponding protocol suitably configured to distinguish group key names to support multiple broadcast and multicast domains. Specifically, one embodiment of the present innovation is directed toward a system and method configured to distinctly establish and name unique group keys in order to support the transmission and recognition of multiple broadcast and multicast communication via an 802.11 network.

In accordance with one embodiment of the present system and method, it will be appreciated that the group keys may be established in the same manner as the group keys are presently handled in accordance with the IEEE 802.11i pre-standard with respect to broadcast transmission and named using similar techniques to how unicast keys keys are named in the IEEE 802.11i pre-standard. Of course, it will be appreciated that alternative methods and encryption techniques may be used to name group keys for broadcast and multicast transmission. As well, it will be appreciated that the group key names contemplated by the present innovation may also be protected by additional verifications in accordance with the IEEE 802.11 standard (e.g. message integrity code).

One embodiment of the disclosed system and method set forth infers the establishment of a trust relationship between an access point (AP) and clients or stations. The following embodiments will be described directed toward an AP as the transmitter and wireless clients (PCs) as the receivers of multicast transmission in an 802.11 network.

Generally, in accordance with one embodiment of the present innovation, upon receipt of a multicast transmission, the system may be suitably configured to enable the receiving clients to extract the group key name included within the packet name in order to discern the intended target group. In the event that the client determines from the key name that it is a member of the intended target group for the transmission, the entire message may be decrypted thereby completing the multicast transmission. However, if following decryption of the key name, a wireless client discerns that it is not a member of the intended target group of the multicast transmission packet, the transmission packet may be discarded prior to any decryption attempt of the message body.

It will be appreciated that the process of establishing the encrypted group keys may be accomplished in accordance with the IEEE 802.11i pre-standard. It will further be appreciated that the present system and method contemplates a novel methodology suitably adapted to name and identify 802.11 multicast group keys and transmissions in order to allow stations to recognize and distinguish data packets identified for a specific station or group of stations.

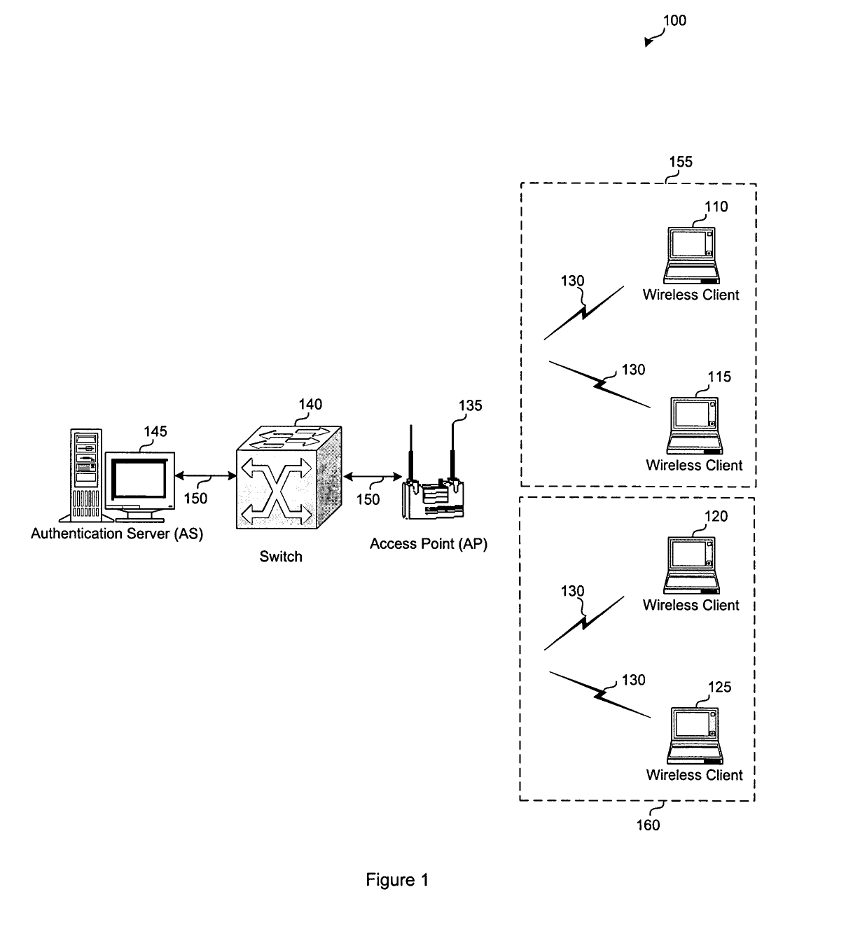

Illustrated in FIG. 1 is a simplified system component diagram of one embodiment of the present system 100. The system components shown in FIG. 1 generally represent the system 100 and may have any desired configuration included within any system architecture.

Referring now to FIG. 1, an embodiment of the system generally includes wireless clients 110, 115, 120, 125 suitably configured and connected to access services on an 802.11 network 130 via an access point (AP) 135. It will be appreciated that the wireless clients 110, 115, 120, 125 may be any component capable of transmitting and/or receiving data packets via a wireless network such as any one of numerous wireless devices, including, but not limited to, a laptop/notebook portable computer (as shown) having a Cardbus network adapter suitable for wireless communication with a wired network, an electronic tablet having a suitable wireless network adapter, a handheld device or personal digital assistant containing a suitable wireless network adapter for communicating to a wired network or the like.

Continued reference to FIG. 1 illustrates that an embodiment of the present system and method may further include a switch 140 and an authentication server (AS) 145. In a basic IEEE 802.11 implementation, a switch 140 may operate to provide interconnectivity between a plurality of network devices disposed on a wired network 150 and optionally between a plurality of networks (not shown).

An AS 145 is disposed on the wired network 150 to provide authentication services to those network entities requiring such a service. Of course, it will be appreciated that the AS 145 and corresponding functionality may be employed as a stand alone component or combined within another existing component. For example, the functionality of the AS 145 may be included within the switch 140 or the AP 135.

Further, it will be appreciated that the AS 145 can be co-located with an authenticator, or it can be accessed remotely via a network to which the authenticator has access. Additionally, the network 150 can be a global communication network, e.g., the Internet, such that authentication occurs over great distances from a remote location disposed thereon to the AS 145.

Illustrated in FIG. 1 is a block diagram of a system that is suitably adapted to operate to control the distribution of multicast communication to wireless clients 110, 115, 120, 125 in accordance with a disclosed embodiment. As in an IEEE 802.11 regime, the present system contemplates that trust relationships and the generation of keys may be established utilizing any known encryption scheme. Of course, the IEEE 802.11 standard provides details and protocols for the establishment of the trust relationships and generation of keys.

As shown in FIG. 1, an AP 135 may be configured to provide the communicative transition point between the dedicated wired network 150 and the wireless clients (or supplicants) 110, 115, 120, 125.

Continuing with the embodiment, illustrated in FIG. 1 are two individual user groups 155, 160. As shown, one group 155 may include multiple wireless clients 110, 115. Likewise, a second group 160 may include multiple wireless clients 120, 125.

Although FIG. 1 illustrates a specific number of user groups (155, 160) operatively connected to AP 135, it will be appreciated that a network may include any number of groups or wireless clients configured to receive multicast or broadcast transmission from a single AP. It will further be appreciated that the groups defined by a network may include any number of clients. Of course, any client may be a member of one or more defined multicast groups.

In accordance with the present system and method, the AP 135 may be configured to name and encrypt a group cipher suite utilizing any one of a number of conventional authentication algorithms known in the art. For example, the present system and method may be configured to utilize authentication algorithms such as EAP-Cisco Wireless, a certificate-based scheme such as EAP-TLS or the like.

In operation, following authentication and the development of a trust relationship between the components on the wired network 150, the AP 135 may commence the transmission of group ciphers. In the embodiment, the AP 135 may be suitably configured to transmit encrypted multicast exchanges to the selected wireless clients 110, 115, 120, 125.

A group key may be derived to be used for multicast transmissions to the identified groups 155, 160 and corresponding wireless clients 110, 115, 120, 125. Subsequently, the AP 135 may be configured extend the packet name of the corresponding transmitted ciphers to include a unique group name.

Continuing with the example of FIG. 1, the AP 135 is suitably configured to establish a group key name for each group cipher using a secure means, for example, a desired hash function. For example, a hash function such as GTK[i]=SHA1−128 (“AP's Group KeyID” ∥BSSID∥VLAN-ID∥128 bit-random-nonce) may be used in order to establish a unique group key name. It will be appreciated that SHA1−128 may be a SHA1 operation truncated to 128. Of course any desired hash function may be used in order to establish a group key name. It will be appreciated that the group key name need not be a function or derivation from the group key itself. Accordingly, the group key may be any uniquely identifiable value. The hash function is one example of how a group key may be named.

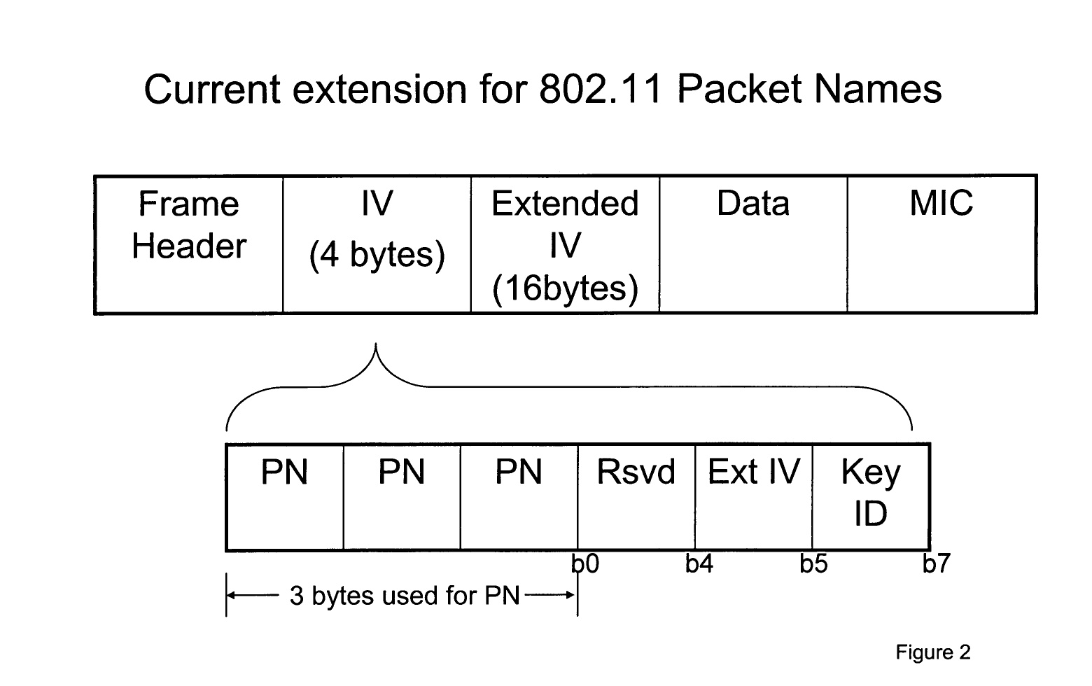

Next, the AP 135 can extend the 802.11 multicast packet name extension for the data packets to include the key name. For example, FIG. 2 illustrates the current convention outlining the format of packet name extensions. As will be appreciated, the packet name extension of FIG. 2 does not include a specific group identifying information element.

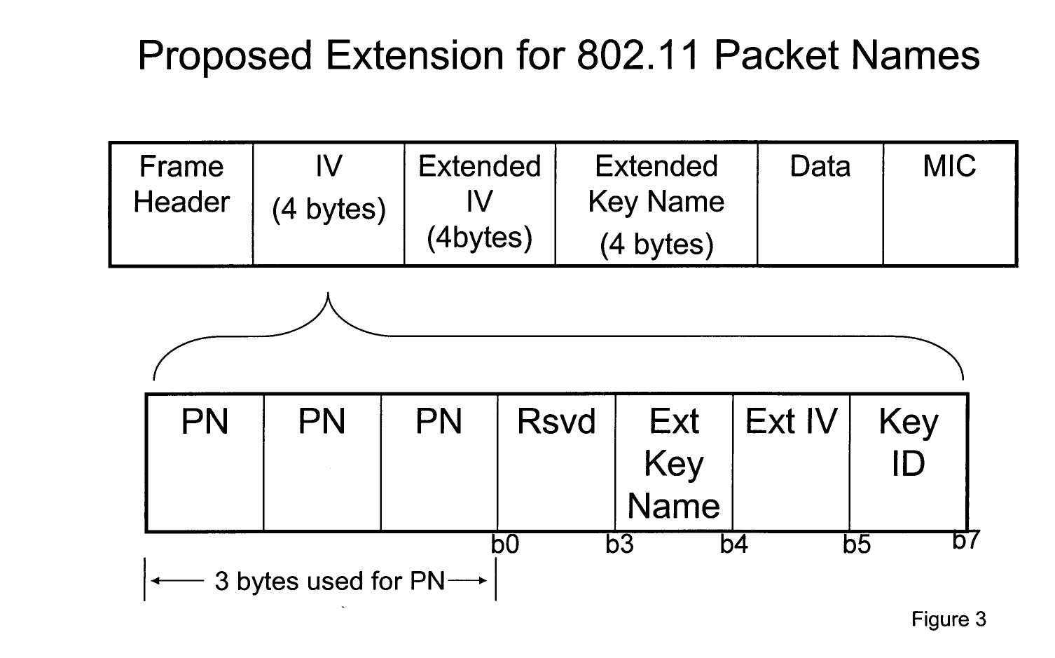

On the other hand, illustrated in FIG. 3 is an example of a proposed modified packet name extension in accordance with one embodiment of the present system and method. As illustrated, an extended key name element is proposed to be included within both the packet name extension as well as in the initialization vector portion of the extension. It will be appreciated that these specific identifiers will be suitably configured to enable a receiver or client to distinguish the target group of a multicast transmission.

Continuing with the example of FIG. 1, once the group key name is embedded into the packet name extension, the data packets may then be transmitted by the AP 135 to the wireless clients 110, 115, 120, 125. The unique key name enables the wireless clients 110, 115, 120, 125 the ability to distinguish if the recipient is an intended addressee of the multicast transmission. Of course, the unique key name may be incorporated into the multicast cipher header or transmitted as a separate distinct packet.

It will be appreciated that the key name for group ciphers may be any preferred length. For example, the key name for a group cipher may be 4 bytes, 8 bytes or the like. Although the disclosed embodiment is directed toward multicast transmission, it will be appreciated that the disclosed concepts may be applied to unicast transmission without departing from the spirit or scope of the present innovation.

According to one embodiment, the AP 135 in conjunction with the switch 140 is suitably adapted to establish a group key to be applied to a multicast transmission. Additionally, the AP 135 and switch 140 are suitably adapted to establish a unique group key name that may be incorporated into a multicast transmission in order to enable a client to determine if it is a member of a targeted transmission group. For example, a multicast transmission may be targeted for a specific defined user group (e.g. group 155) of clients whereby, wireless clients 110, 115 may affirmatively determine that they are members of the target group. On the other hand, wireless clients 120, 125 in group 160 may determine from the key name that they are not members of the targeted group.

Next, the AP 135 transmits the group cipher along with the unique group key and key name to the wireless clients 110, 115, 120, 125. Once the group cipher is received along with the group key and key name, the group key name is validated by the wireless clients 110, 115, 120, 125.

In order to determine if the wireless clients 110, 115, 120, 125 is a member of the intended targeted group for the multicast transmission, the wireless client 110, 115, 120, 125 compares the validated group key name to elements contained within a local data table.

As stated earlier, if a key name in the data table matches the received group key name, the message is deemed correctly delivered thereby prompting decryption of the entire message packet. If no key name in the local data table matches the received group key name, the message is discarded prior to any decryption attempt.

The AP 135 and the wireless clients 110, 115, 120, 125 continue to exchange information using a known protocol. Throughout the exchanges, the wireless clients 110, 115, 120, 125, in accordance with the key name comparison process previously described, either accept and decrypt the entire packet traffic, or discard the traffic prior to decryption attempts.

Of course, it will be appreciated that the group key and key name transmission may be configured to be protected by a message integrity check (MIC) key or other information element which may be subject to authorization utilizing a known authentication protocol (e.g. EAP).

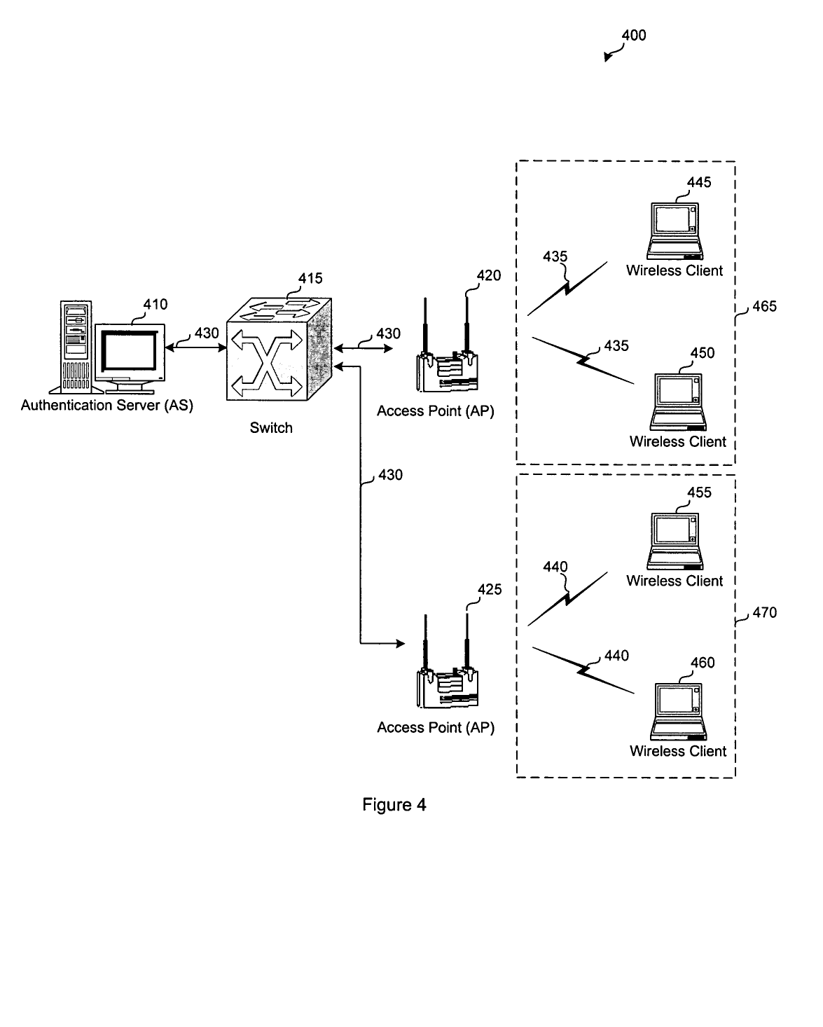

Referring now to FIG. 4, there is illustrated a general block diagram of an alternative embodiment of the present system and method utilizing the described protocol. The system 400 includes an authentication server (AS) 410, switch 415 and multiple access points (AS) 420, 425 disposed on a wired network 430.

In this particular embodiment, the functionality of the switch 140 of FIG. 1 is the same as the switch 415. However, the architecture as shown in FIG. 4 includes multiple 802.11 networks or multicast and broadcast domains 435, 440. Accordingly, the APs 420, 425 are configured communicate multicast ciphers to the wireless clients 445, 450, 455, 460 via wireless networks 435, 440. Thus, as described with reference to FIG. 1, the APs 420, 425 are suitably configured to establish group keys and unique key names utilizing a suitable protocol in order to transmit multicast packets to designated groups 465, 470. As described with reference to FIG. 1, the wireless clients 445, 450, 455, 460 are suitably configured to receive multicast transmissions and discern if they are a member of the intended target group based upon decryption of the group key name and comparison to a predefined key name table.

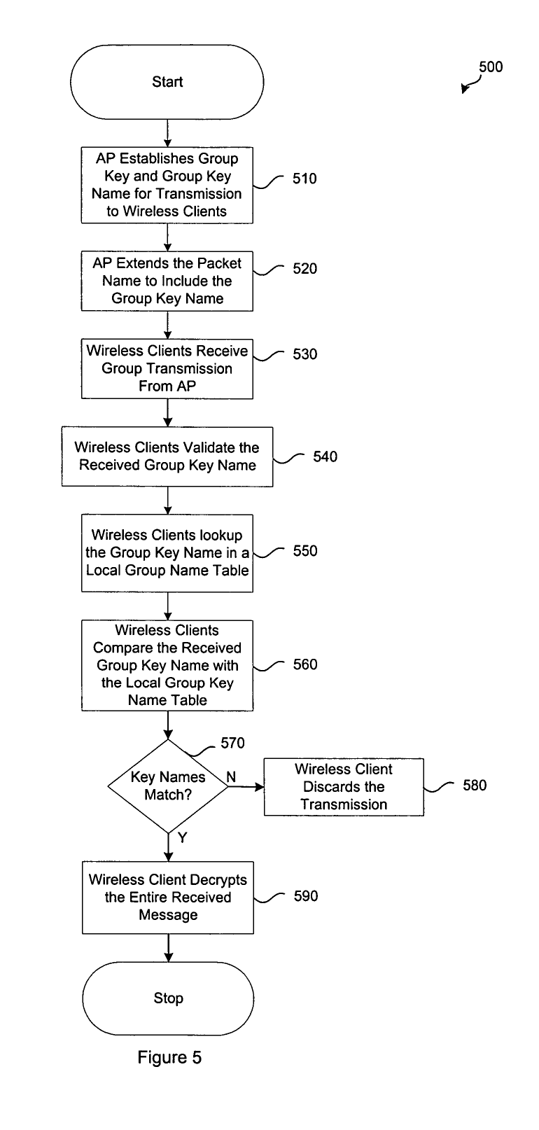

Illustrated in FIG. 5 is an embodiment of a methodology 500 associated with the present system and method. Generally, FIG. 5 illustrates the process used to establish and transmit unique group keys and key names together with multicast communications on an 802.11 wireless network.

The illustrated elements denote “processing blocks” and represent computer software instructions, logic or groups of instructions that cause a computer or processor to perform an action(s) and/or to make decisions. Alternatively, the processing blocks may represent functions and/or actions performed by functionally equivalent circuits such as a digital signal processor circuit, an application specific integrated circuit (ASIC), or other logic device. The diagram, as well as the other illustrated diagrams, does not depict syntax of any particular programming language. Rather, the diagram illustrates functional information one skilled in the art could use to fabricate circuits, generate computer software, or use a combination of hardware and software to perform the illustrated processing.

It will be appreciated that electronic and software applications may involve dynamic and flexible processes such that the illustrated blocks can be performed in other sequences different than the one shown and/or blocks may be combined or separated into multiple components. They may also be implemented using various programming approaches such as machine language, procedural, object oriented and/or artificial intelligence techniques. The foregoing applies to all methodologies described herein.

Referring now to FIG. 5, there is illustrated a flow chart of an embodiment of the methodology 500 for the establishment, transmission and recognition of unique group key names via an 802.11 wireless network. The methodology 500 infers the pre-establishment of a trusted relationship between all components of the system (e.g. wireless clients, AP, switch, AS).

Initially, at block 510, the AP establishes a unique group key and group key name utilizing a network defined key management protocol (e.g. EAPOL) to be used in connection with multicast transmission to a group of wireless clients. The 802.11 packet name of the data packets are extended to include this unique group key name (block 520). Next, at block 530, the wireless clients receive the multicast transmission from the AP including the unique group key name.

Upon receipt, the wireless clients locally validate the group key name (block 540). It will be appreciated that the wireless clients receive group key name may be embedded into the packet name extension and transmitted together with the complete transmitted data packet.

Continuing with the embodiment, in accordance with the validation procedure, the wireless clients lookup the decrypted group key name in a local group name table (block 550). Next, at block 560, the wireless clients compare the received group key name with the names contained within a local key name table to determine if the wireless client is an intended target for the multicast transmission.

If at decision block 570 the received group key name does not match the group key name in the wireless client lookup table, the wireless client discards the transmission prior to attempting any further decryption (block 580).

On the other hand, if, at decision block 570, the received group key name does match a group key name contained in the wireless client table, the wireless client decrypts the remaining portion of the data packet and accepts the transmission (block 590).

While the present system has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the system, in its broader aspects, is not limited to the specific details, the representative apparatus, and illustrative examples shown and described. Accordingly, departures may be made from such details without departing from the spirit or scope of the applicant's general inventive concept.

Although the preferred embodiment has been described in detail, it should be understood that various changes, substitutions and alterations can be made therein without departing from the spirit and scope of the invention as defined by the appended claims.

1. A method for validating an electronic transmission, the method comprising the steps of:
generating a group key for encrypting and signing an electronic message transmitted on a network;
establishing a group key name corresponding to the group key for encrypting and signing the electronic message transmitted to a group of clients on the network;
transmitting a data packet, the data packet including the group key name, the electronic message and a signature to authenticate the electronic message and protect and group key name;
receiving the data packet; and
validating the group key name in the received data packet.

2. The method set forth in claim 1 further comprising the step of adding the group key name and the message authentication signature to a packet name extension prior to the step of transmitting.

3. The method set forth in claim 1 wherein the step of transmitting includes transmitting in accordance with an 802.11 protocol.

4. The method set forth in claim 1 further comprising the step of establishing an authenticated relationship.

5. The method set forth in claim 4 wherein the step of establishing an authenticated relationship employs a handshake protocol.

6. The method set forth in claim 1 wherein the step of validating further includes the step of comparing the received group key name to a group key name table.

7. The method set forth in claim 6 further comprising the steps of:
establishing a local group key name; and
storing the locally established group key name in the group key name table.

8. The method set forth in claim 1 further comprising the step of encrypting the multicast message prior to transmission.

9. The method set forth in claim 1 further comprising the step of decrypting the received multicast message if the received group key name matches an entry in the group key name table.

10. The method set forth in claim 1 further comprising the step of discarding the received multicast message if the received group key name does not match an entry in the group key name table.

11. A system for targeting multicast transmission, the system comprising:
means for generating a group key for signing a multicast message transmitted via a network;
means for generating a group key name for naming the group key;
means for combining the group key name to the multicast message to form a multicast packet;
means for transmitting the multicast packet to a receiver via the network;
means for receiving the multicast packet;
means for validating the received group key name contained within the received multicast packet; and
means for determining the intended group recipients based upon the validated group key name.

12. The system set forth in claim 11 wherein the means for determining further includes means for comparing to a local group name table.

13. The system set forth in claim 11 wherein the means for transmitting the management frame packet is an IEEE 802.11 protocol.

14. The system set forth in claim 11 wherein the means for generating a group key is in accordance with an IEEE 802.1 pre-standard.

15. The system set forth in claim 11 wherein the group key name is a unique identifying element.

16. An article of manufacture embodied in a computer-readable medium for use in a processing system for transmitting electronic messages to and/or from a network, the article comprising:
a group key generation logic for causing a processing system to generate a group key for encrypting and signing an electronic message transmitted on a network;
a group key name generation logic for causing a processing system to generate a group key name for encrypting and signing the electronic message transmitted on the network;
a data transmitting logic for causing a processing system to transmit the electronic message to a group of clients on the network; and
a message receiving logic for causing a processing system to verify whether a receiving client is an intended recipient of the electronic message.

17. The article as set forth in claim 16 wherein the data transmitting logic includes an IEEE 802.11 protocol.

18. The article as set forth in claim 16 wherein the message receiving logic further includes means for causing a processing system to compare a received group key name with a local key name table.
